(19) United States
(12) Patent Application Publication
(10) Pub. No.: US 2003/0039456 A1
(43) Pub. Date: Feb. 27, 2003

(54) Optical module, optical transmitter and optical receiver

(76) Inventor: Minoru Tajima, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/061,298

(22) Filed: Feb. 4, 2002

(30) Foreign Application Priority Data
Aug. 14, 2001 (JP) 2001-246115

(51) Int. Cl. G02B 6/42

(52) U.S. Cl. 385/92

(57) ABSTRACT

A pair of dielectric windows are respectively formed in a side wall of a metallic package of an optical module in an almost U shape on the side wall surface by packing a dielectric substance in the dielectric windows, and each dielectric window is used as a feed through unit through which a high-frequency signal or a voltage signal is transmitted from the outside to an optical semiconductor element of the optical module. An electromagnetic wave can be transmitted through each dielectric window, and a cutoff frequency of the dielectric window for the electromagnetic wave is considerably lowered as compared with that of a rectangular electromagnetic window in which a length of a longer side is the same as that of the dielectric window. Accordingly, unnecessary electromagnetic waves including electromagnetic waves of low frequencies can be reliably discharged from a cavity of the package to the outside through the dielectric windows, and a cavity resonance of the unnecessary electromagnetic waves in the cavity can be reliably weakened.

### BACKGROUND OF THE INVENTION 1. Field of the Invention

The present invention relates to an optical module, an optical transmitter and an optical receiver in which an optical semiconductor element is arranged.

2. Description of Related Art

An optical module has been used. In a type of optical module, a high-frequency signal is input to a laser diode, and an optical signal output from the laser diode is coupled to an optical fiber. Also, in another type of optical module, a first optical signal is input to an electroabsorption element (hereinafter, called EA element) through a first optical fiber, the first optical signal is modulated in the EA element according to a high-frequency signal, and the modulated signal is coupled to a second optical fiber as a second optical signal.

In these types of optical modules, to shield optical elements of each optical module from external noise, the optical module is formed in a package shape, an optical semiconductor element representing the laser diode or the EA element is surrounded by a conductive wall.

FIG. 19A and FIG. 19B are schematic views respectively showing an external structure of a conventional optical module having a laser diode. FIG. 19A is a front view of the conventional optical module seen from an optical fiber, and FIG. 19B is a side view of the conventional optical module seen from a high-frequency signal supply side.

In FIG. 19A and FIG. 19B, 101 indicates a closed box-type package made of a conductive substance, and the package 101 shields constitutional elements of the optical module from the outside. In the package 101, optical elements (not shown) such as a laser diode and a lens and an electronic circuit (not shown) are arranged. 102 indicates a feed through unit formed in a rectangular shape in section. The feed through unit 102 is filled with a dielectric substance. The feed through unit 102 is arranged in each of a pair of side walls of the package 101, and the pair of side walls face each other. 103 indicates each of a plurality of lead pins inserted into each feed through unit 102. Various electric signals including a high-frequency signal are transmitted between an external device and the group of the optical elements and the electronic circuit arranged in the package 101. 104 indicates a lens window arranged in a circular window of a side wall (or a front wall) of the package 101. The side wall including the lens window 104 differs from the pair of side walls of the package 101 in which the feed through units 102 are arranged. An optical signal radiated from a laser diode according to the high-frequency signal is transmitted through the lens window 104. 105 indicates an optical fiber for receiving the optical signal transmitted through the lens window 104 and leading the optical signal to an external device.

Constitutional elements of the conventional optical module other than the feed through units 102 and the lens window 104 are surrounded by conductive walls of the package 101 and are shielded from external electromagnetic field. Also, the constitutional elements of the conventional optical module are hermetically sealed by the package 101 composed of the lens 104, the feed through units 102 and a package base 101b, and the conventional optical module is formed in a hermetic structure. Therefore, the conventional optical module having the conductive walls has an internal cavity (hereinafter, simply called cavity).

In the above-described configuration of the conventional optical module, when the high-frequency signal of a micro wave or a millimeter wave is input to a connection wire (not shown) of the conventional optical module through one lead pin 103 of one feed through unit 102, a part of the high-frequency signal sometimes leaks out into the cavity due to an impedance mismatching occurring in the connection wire, and the part of the high-frequency signal is scattered in the cavity. In this case, resonance (hereinafter, called cavity resonance) of the high-frequency signal easily occurs in the cavity of the package 101 due to the scattering of the high-frequency signal.

Assuming that a high-frequency signal is scattered in a closed cavity formed in a rectangular parallelepiped shape, a frequency Fr of the high-frequency signal causing the cavity resonance is expressed according to an equation (1).

Fr=Cₒ/2×√{(L/A)²+(M/B)²+(N/C)²} (1)

Here, the symbol Cₒ denotes a light velocity (2.9979×10⁸ m/s), the symbols A, B and C denote lengths (in meter) of three sides of the rectangular parallelepiped, and the symbols L, M and N denote coefficients equal to zero or positive integral numbers respectively. There is no case where two or more of the coefficients L, M and N are simultaneously equal to zero. As an example, in cases where A=B=0.02 m and C=0.01 mare satisfied, a lowest resonance point (or a lower limit resonance frequency) corresponding to L=M=1 and N=0 exists, and the lower limit resonance frequency is about 10.6 GHz. Therefore, an infinite number of resonance points (or resonance frequencies) exist in a frequency band equal to or higher than the resonance frequency of about 10.6 GHz.

In an optical module actually existing, optical elements and an electronic circuit are arranged in the cavity. Therefore, the cavity of the package 101 is not actually formed in the rectangular parallelepiped shape but is formed in a complicated shape. Therefore, the resonance frequency cannot be simply expressed according to the equation (1). However, in cases where optical elements and an electronic circuit are arranged in the cavity of the package 101, the lower limit resonance frequency is generally lowered as compared with that obtained in the cavity of the rectangular parallelepiped shape.

In cases where the cavity resonance occurs in the package 101, an electronic circuit of the package 101 is unstably operated, and a signal oscillation is easily generated in the electronic circuit. Therefore, it is required to lower the intensity of the high-frequency signal relating to the cavity resonance for the purpose of weakening the cavity resonance, and it is required to prevent the cavity resonance if possible. As a method of weakening the cavity resonance, there is a case where an electromagnetic wave absorptive element is attached to an inner surface of a wall of the package 101 to absorb an unnecessary electromagnetic wave such as a scattered high-frequency signal.

Also, in another method of weakening the cavity resonance, a radio wave window made of a dielectric substance is arranged in a wall of the package, and an unnecessary electromagnetic wave such as a high-frequency signal scattered in the package 101 is discharged to the outside through the radio wave window. Because each feed through unit 102 is generally filled with the dielectric substance such as ceramic, the feed through unit 102 functions as a radio wave window having an almost rectangular shape on the side wall surface for the electromagnetic wave. Therefore, a part of the unnecessary electromagnetic wave such as a high-frequency signal is discharged to the outside through the feed through unit 102 functioning as the radio wave window. That is to say, the feed through units 102 function so as to weaken the cavity resonance.

However, because the conventional optical module has the above-described configuration, in cases where the electromagnetic wave absorptive element is attached to an inner wall surface of the package 101 to absorb an unnecessary electromagnetic wave such as a scattered high-frequency signal, outgas is discharged from the electromagnetic wave absorptive element to the cavity. The outgas covers an optical semiconductor element such as a laser diode or an EA element and a lens. Also, the outgas solidifies and is attached to the optical semiconductor element and the lens. Therefore, a problem has arisen that the performance of the optical semiconductor element and the lens is degraded.

Also, in cases where the radio wave window made of a dielectric substance is arranged in a package wall to discharge an unnecessary electromagnetic wave such as a high-frequency signal scattered in the package 101 to the outside through the radio wave window, a size of the radio wave window is lessened as a size of the package 101 is made smaller. Therefore, a problem has arisen that a lower cutoff frequency of the radio wave window is heightened. In cases where a wavelength of the electromagnetic wave is longer than a length which is double of a diameter of the radio wave window, it is impossible to transmit the electromagnetic wave through the radio wave window. Therefore, in case of the small-sized radio wave window, it is impossible to discharge an electromagnetic wave having a low frequency to the outside of the conventional optical module.

Also, in cases where the conventional optical module is used for a large capacity type of optical transmitter, a large capacity type of optical receiver or a large capacity type of optical transceiver, the intensity of a high-frequency signal received in the laser diode is considerably changed due to the cavity resonance in dependence on the wavelength of the high-frequency signal, and the intensity of an optical signal radiated from the laser diode is considerably changed in dependence on the intensity of the high-frequency signal.

FIG. 20 is an explanatory view showing a frequency characteristic of the intensity of an optical signal radiated from a laser diode.

As shown in FIG. 20, because the intensity of a high-frequency signal received in the laser diode is considerably reduced at a plurality of resonance points of the cavity resonance, the intensity of an optical signal radiated from the laser diode is considerably changed. Therefore, a problem has arisen that the optical signal radiated from the laser diode is degraded.

### SUMMARY OF THE INVENTION

An object of the present invention is to provide, with due consideration to the drawbacks of the conventional optical module, an optical module in which the cavity resonance of electromagnetic waves including a low-frequency electromagnetic wave is reliably weakened so as not to degrade the performance of the optical module.

Also, the object of the present invention is to provide an optical transmitter using the optical module.

Also, the object of the present invention is to provide an optical receiver using the optical module.

The object of the present invention is achieved by the provision of an optical module comprising an optical semiconductor element, and a package, having at least a wall made of both a conductive substance and a dielectric substance, and having a cavity in which the optical semiconductor element is placed. The wall has a window made of the dielectric substance, and the window includes a U-shaped portion.

In the above configuration, because the window formed in the U shape is arranged in the wall of the package, a lower cutoff frequency of the window for an electromagnetic wave is considerably lowered. Also, in cases where the window is made of the dielectric substance of a low relative dielectric constant, the transmittance of the electromagnetic wave in the window is considerably heightened. Accordingly, even though unnecessary electromagnetic waves including a low-frequency electromagnetic wave are generated in the cavity of the package, the cavity resonance of the unnecessary electromagnetic waves in the cavity can be reliably weakened.

It is preferred that the window includes a feed through unit.

Therefore, the window can function as a feed through unit.

It is preferred that the wall has a wall portion surrounding the window, and the wall portion is made of only a conductive substance.

Therefore, the window is reliably arranged in the wall.

It is also preferred that the wall has a wall portion surrounding the window, and the wall portion has a conductive layer and a dielectric layer.

Therefore, the window is reliably arranged in the wall.

It is also preferred that a cut-off frequency of the window for an electromagnetic wave is lower than that of a wave guide of which a lengthwise width is equal to a lengthwise width of the window, and the electromagnetic wave having a frequency higher than the cut-off frequency of the window is transmitted through the window.

Because the window functions as a Ridge waveguide, the cut-off frequency of the window for an electromagnetic wave can be lowered.

It is also preferred that the window is formed of a ridge waveguide.

Therefore, the cut-off frequency of the window for an electromagnetic wave can be lowered.

It is also preferred that a cut-off frequency of the window for an electro-magnetic wave is lower than a frequency of a cavity resonance occurring in the package, and the electromagnetic wave having a frequency higher than the cut-off frequency of the window is transmitted through the window.

Therefore, the cavity resonance occurring in the package can be reliably weakened.

It is also preferred that a cut-off frequency Fc₁ of the window for an electro-magnetic wave is approximately expressed according to an equation

$${Fc}_{1} = \frac{{C}_{0}}{π \sqrt{{ϵ}_{r}} \sqrt{( \frac{2 {C}_{d}}{{ϵ}_{0}} + \frac{{A}_{2}}{{B}_{2}} ) ( {A}_{1} - {A}_{2} ) {B}_{1}}}$$

by using an external length A₁ of the window, an internal length A₂ of the window, an external width B₂ of the window, an internal width B₂ of the window, a relative dielectric constant εᵣ of the dielectric substance and a dielectric constant ε₀ of a vacuum, and a coefficient C_{d} is expressed according to equations

$$\begin{matrix}{C}_{d} = \frac{{ϵ}_{0}}{x} \{ \frac{1 + {x}^{2}}{x} {cosh}^{- 1} ( \frac{1 + {x}^{2}}{1 - {x}^{2}} ) - 2 ln ( \frac{4 x}{1 - {x}^{2}} ) \} \\ x = \frac{{B}_{2}}{{B}_{1}}\end{matrix}$$

by using the dielectric constant ε_{0,} a frequency Fr of a cavity resonance occurring in the package is expressed according to an equation

$$Fr = \frac{{C}_{0}}{2} \sqrt{{( \frac{l}{A} )}^{2} + {( \frac{m}{B} )}^{2} + {( \frac{n}{C} )}^{2}}$$

by using a speed C₀ of light in the vacuum, lengths (in meters) A, B and C of three sides of the package and arbitrary integers l, m and n equal to or higher than 0 satisfying a condition that at least one of the arbitrary integers is not equal to 0, and the external length A₁, the internal length A₂, the external width B₁ and the internal width B₂ in the window and the lengths A, B and C of the package are set so as to make the cut-off frequency Fc₁ of the window lower than the frequency Fr of the cavity resonance occurring in the package.

Therefore, the cut-off frequency Fc₁ of the window can be made lower than the frequency Fr of the cavity resonance occurring in the package.

It is also preferred that a cut-off frequency of the window for an electromagnetic wave is lower than that which is obtained by covering the dielectric substance exposed to the surface of the wall with the conductive substance so as to make the dielectric substance in a rectangular shape, and the electromagnetic wave having a frequency higher than the cut-off frequency of the window is transmitted through the window.

Therefore, because the window formed in the U shape functions as a Ridge waveguide, the cut-off frequency of the window for an electromagnetic wave can be lowered.

It is also preferred that the package is formed in an almost box shape, and the window is arranged on a surface of the wall of the package.

Therefore, unnecessary electromagnetic waves occurring in the cavity can be discharged to the outside of the package through the window.

It is also preferred that an inner surface of the wall of the package is metallized, and the window is arranged on the inner surface of the wall of the package.

Therefore, unnecessary electromagnetic waves occurring in the cavity can be discharged to the outside of the package through the window.

It is also preferred that an outer surface of the wall of the package is metallized, and the window is arranged on the outer surface of the wall of the package.

Therefore, unnecessary electromagnetic waves occurring in the cavity can be discharged to the outside of the package through the window.

It is also preferred that the package is formed in an almost box shape, and the window is arranged in a side area of the wall of the package.

Therefore, unnecessary electromagnetic waves occurring in the cavity can be discharged to the outside of the package through the window.

It is also preferred that the package is formed in an almost box shape, and the window is arranged in an upper area of the wall of the package.

Therefore, unnecessary electromagnetic waves occurring in the cavity can be discharged to the outside of the package through the window.

It is also preferred that the package is formed in an almost box shape, and the window is arranged in both a side area and an upper area of the wall of the package.

Therefore, unnecessary electromagnetic waves occurring in the cavity can be discharged to the outside of the package through the window.

It is also preferred that the window is formed in a U shape.

Therefore, a lower cutoff frequency of the window for an electromagnetic wave can be lowered.

It is also preferred that the window is formed in a shape which is obtained by outwardly widening both ends of a U shape.

Therefore, even though the shape of the window differs from the U shape, a lower cutoff frequency of the window for an electromagnetic wave can be lowered.

It is also preferred that the window is formed in an almost H shape.

Therefore, a lower cutoff frequency of the window formed in the almost H shape for an electromagnetic wave can be lowered.

It is also preferred that the window is formed in a shape which is obtained by forming a concavity on each of four sides of a rectangle.

Therefore, a lower cutoff frequency of the window formed in the shape for an electromagnetic wave can be lowered.

It is also preferred that the window has a lead line through which a high frequency signal received or output in/from the optical semiconductor element is transmitted.

Therefore, the window can function as a feed through unit.

It is also preferred that the window made of the dielectric substance of the package comprises a feed through unit formed of an almost T-section bar, through which a high frequency signal received or output in/from the optical semiconductor element is transmitted, and a pair of open ends which are respectively protruded from both ends of the feed through unit and are formed in a rectangular shape in section respectively, and an inner surface or an outer surface of the wall of the package except for the window is metallized.

Therefore, the feed through unit can be efficiently used as a part of the window.

It is also preferred that the package further comprises a lens, through which an optical signal received or output in/from the optical semiconductor element is transmitted, arranged in the wall, and the window is arranged so as to surround the lens.

Therefore, the window can be easily arranged around the lens.

It is also preferred that the package is hermetically sealed.

Therefore, constitutional elements arranged in the package can be shielded from dust of the air.

It is also preferred that the optical semiconductor element is formed of a laser diode.

Therefore, an optical signal output from the laser diode is not degraded.

The object is also achieved by the provision of an optical transmitter, comprising an interface unit for receiving a plurality of electric signals and outputting a high frequency signal, and an optical module for receiving the high frequency signal from the interface unit and outputting an optical signal. The optical module comprises an optical semiconductor element for producing the optical signal in response to the high frequency signal transmitted from the interface unit, and a package, having at least a wall made of both a conductive substance and a dielectric substance and having a cavity in which the optical semiconductor element is placed. The wall has a window made of the dielectric substance, and the window includes a U-shaped portion.

Accordingly, the optical transmitter can be obtained by using the optical module in which the cavity resonance of unnecessary electromagnetic waves including a low-frequency electromagnetic wave in the cavity is reliably weakened.

It is preferred that the optical transmitter further comprises an electromagnetic wave absorptive element which is arranged in an outside area of the package so as to face the window of the optical module.

Therefore, the optical module of the optical transmitter can be shielded from an external electromagnetic wave.

It is also preferred that the interface unit comprises a multiplexer for multiplexing the electric signals to produce the high frequency signal.

Therefore, an optical signal produced from the electric signals can be output from the optical transmitter.

It is also preferred that the optical semiconductor element of the optical module is formed of a laser diode, and the interface unit further comprises a driver circuit for amplifying the high frequency signal produced by the multiplexer to output an amplified high frequency signal to the laser diode.

Therefore, an optical signal produced according to the high frequency signal in the laser diode can be output from the optical transmitter.

It is also preferred that the optical transmitter further comprises a second optical module for receiving an electric signal and outputting a second signal. The optical module is a first optical module having the optical semiconductor element formed of an electroabsorption element. The first optical module comprises a driver circuit for amplifying the high frequency signal produced by the multiplexer and outputting an amplified high frequency signal to the electroabsorption element to make the electroabsorption element convert the second optical signal output from the second optical module into the optical signal according to the amplified high frequency signal and output the optical signal.

Therefore, the optical transmitter can be obtained from the first optical module and the second optical module.

It is also preferred that the driver circuit is placed in the cavity of the package.

Therefore, the optical transmitter can be obtained by using the first optical module in which the driver circuit is placed.

The object is also achieved by the provision of an optical receiver, comprising an optical module for receiving an optical signal and outputting a high frequency signal, and an interface unit for receiving the high frequency signal from the optical module and outputting electric signals. The optical module comprises a photo diode for producing the high frequency signal in response to the optical signal, and a package, having at least a wall made of both a conductive substance and a dielectric substance and having a cavity in which the photo diode is placed. The wall has a window made of the dielectric substance, and the window includes a U-shaped portion.

Accordingly, the optical receiver can be obtained by using the optical module in which the cavity resonance of unnecessary electromagnetic waves including a low-frequency electromagnetic wave in the cavity is reliably weakened.

It is preferred that the interface unit comprises a demultiplexer for demultiplexing the high frequency signal produced by the photo diode to produce electric signals.

Therefore, the electric signals can be obtained in the optical receiver.

It is also preferred that the interface unit further comprises an amplifier for amplifying the high frequency signal and outputting an amplified high frequency signal to the demultiplexer to make the demultiplexer produce the electric signals from the amplified high frequency signal.

Therefore, the electric signals can be obtained from the amplified high frequency signal in the optical receiver.

### BRIEF DESCRIPTION OF THE DRAWINGS

FIG. 1 is a diagonal view showing an external structure of an optical module according to a first embodiment of the present invention;

FIG. 2A is a transverse cross sectional view showing the configuration of an optical module shown in FIG. 1;

FIG. 2B is a vertical cross sectional view taken substantially along line A-A of FIG. 2A;

FIG. 3 is a diagonal view showing a dielectric window shown in FIG. 1;

FIG. 4 is a side view showing an external structure of the optical module seen from the front of the dielectric window (placed on a viewer side in FIG. 1 and placed on the left side in FIG. 2A) shown in FIG. 1;

FIG. 5 is a diagonal view showing a general rectangular waveguide;

FIG. 6A shows a step of placing the dielectric window on a package base;

FIG. 6B shows a step of placing a package cover and a seal ring on the dielectric window;

FIG. 7A, FIG. 7B and FIG. 7C are explanatory views showing the procedure of manufacturing a package according to a first modification of the first embodiment;

FIG. 8A, FIG. 8B, FIG. 8C and FIG. 8D are explanatory views showing the procedure of manufacturing a package according to a second modification of the first embodiment;

FIG. 9 is a view showing a sectional shape of the dielectric window on a dielectric wall surface according to a third modification of the first embodiment;

FIG. 10 is a view showing a sectional shape of the dielectric window on a dielectric wall surface according to a fourth modification of the first embodiment;

FIG. 11 is a view showing a sectional shape of the dielectric window on a dielectric wall surface according to a fifth modification of the first embodiment;

FIG. 12 is a diagonal view showing an external structure of an optical module according to a second embodiment of the present invention;

FIG. 13 is a diagonal view of a dielectric window shown in FIG. 12;

FIG. 14 is a diagonal view showing an external structure of an optical module according to a modification of the second embodiment;

FIG. 15 is a block diagram showing the configuration of an optical transmitter according to a third embodiment of the present invention;

FIG. 16 is a block diagram showing the configuration of an optical receiver according to the third embodiment of the present invention;

FIG. 17 is a transverse cross sectional view showing the internal configuration of an optical transmitter according to a modification of the third embodiment;

FIG. 18 is a block diagram showing the configuration of an optical transmitter according to a fourth embodiment of the present invention;

FIG. 19A and FIG. 19B are schematic views respectively showing an external structure of a conventional optical module having a laser diode; and

FIG. 20 is an explanatory view showing a frequency characteristic of the intensity of an optical signal radiated from a laser diode.

### DETAILED DESCRIPTION OF THE PREFERRED EMBODIMENTS

Embodiments of the present invention will now be described with reference to the accompanying drawings.

Embodiment 1

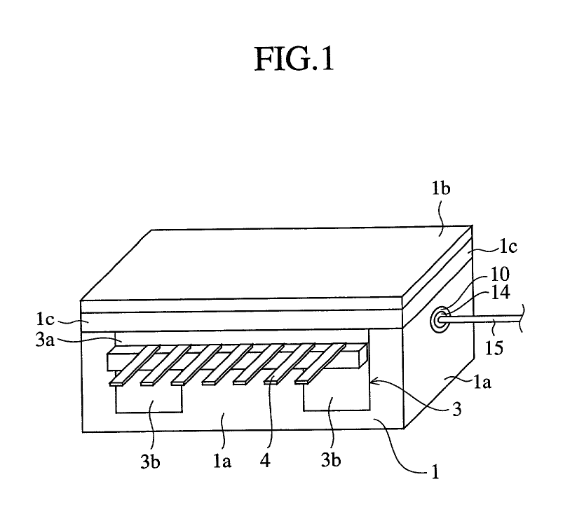

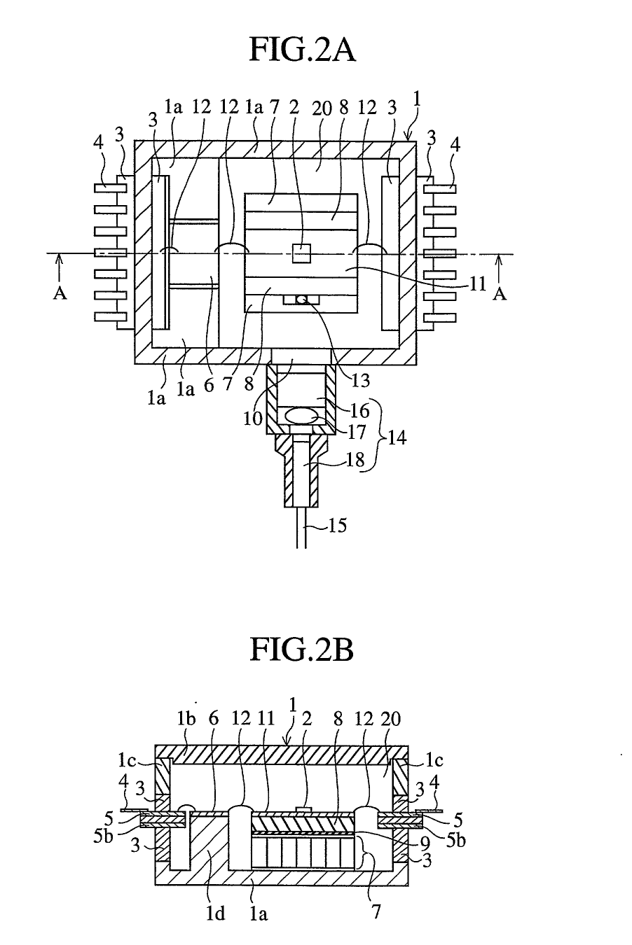

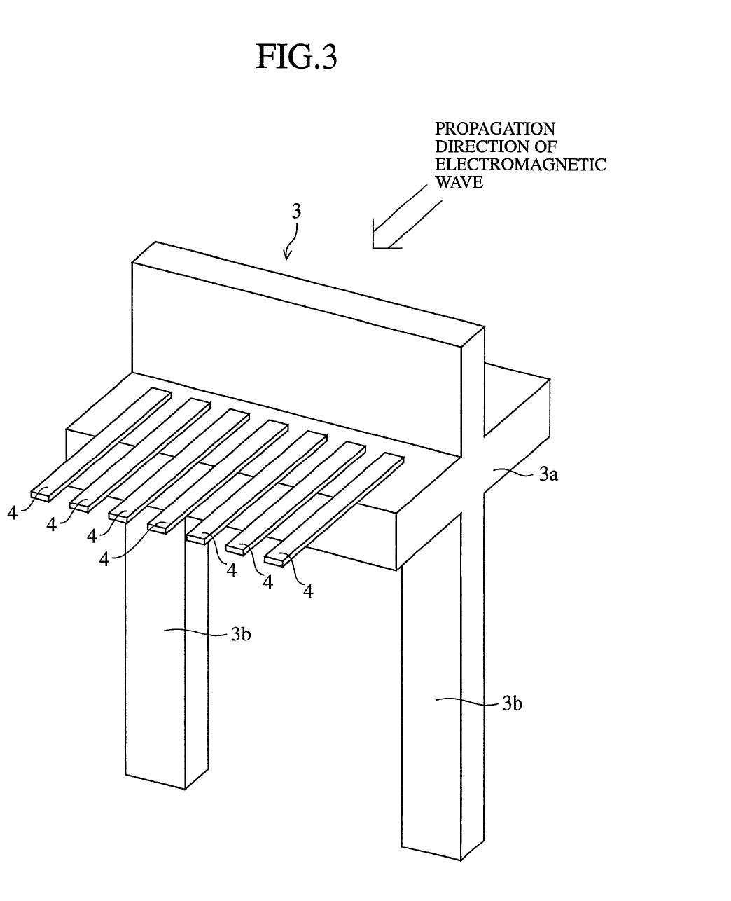

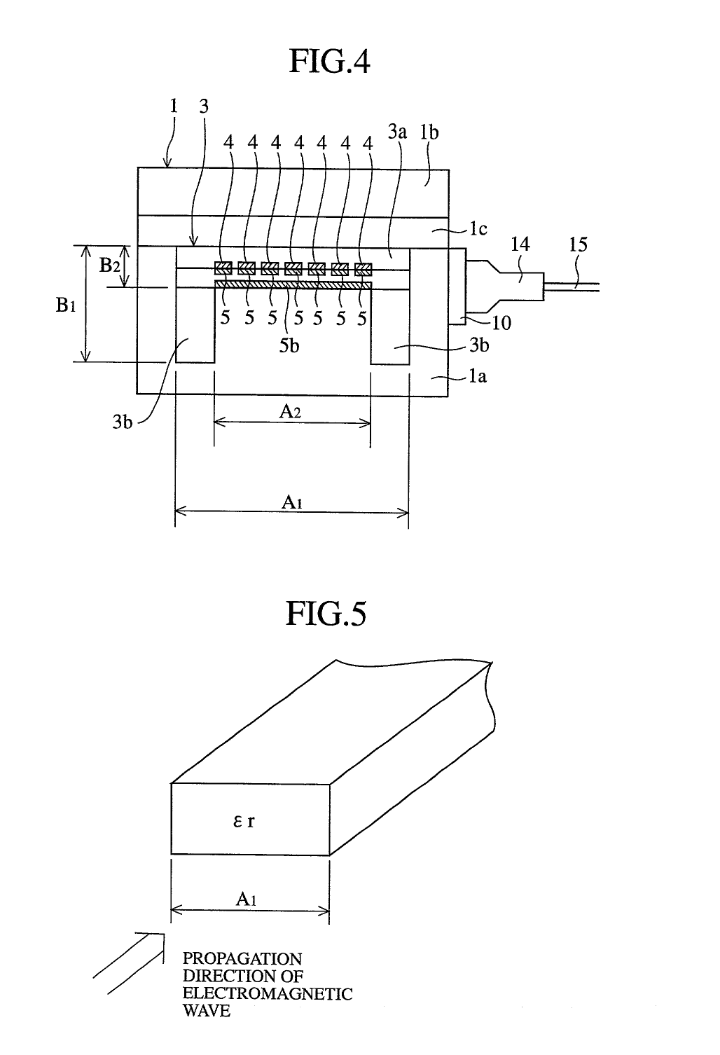

FIG. 1 is a diagonal view showing an external structure of an optical module according to a first embodiment of the present invention, FIG. 2A is a transverse cross sectional view showing the configuration of an optical module shown in FIG. 1, FIG. 2B is a vertical cross sectional view taken substantially along line A-A of FIG. 2A, FIG. 3 is a diagonal view showing a dielectric window shown in FIG. 1, and FIG. 4 is a side view showing an external structure of the optical module seen from the front of the dielectric window (placed on a viewer side in FIG. 1 and placed on the left side in FIG. 2A) shown in FIG. 1. Here, a sectional view of a feed through unit seen from the right side of FIG. 2A is substantially the same as that shown in FIG. 4.

In FIG. 1 and FIG. 2, 1 indicates a package made of a box-shaped metal (or a conductive substance), and the package 1 shields internal elements of an optical module from an external electromagnetic wave. The package 1 has a plurality of walls made of both a conductive substance and a dielectric substance and has a cavity 20. The package 1 comprises a package base 1a (first area), a package cover 1b (first area), a seal ring 1c (first area) placed between the package base 1a and the package cover 1b, a pair of dielectric windows (second area) described later in detail and a lens window described later. Also, a package box described later in detail comprises the dielectric windows, the lens window, the package base 1a and the seal ring 1c placed between the package base 1a and the package cover 1b. 2 indicates an optical semiconductor element (for example, a laser diode), placed in the package 1, for receiving a high-frequency signal and radiating an optical signal.

3 indicates each of the dielectric windows respectively having an electric interface function of a feed through unit 3a. The entire structure of each dielectric window 3 is shown in FIG. 3. The dielectric windows 3 are formed by packing a dielectric substance such as ceramic into a pair of almost U shaped window portions (through holes) opened in right and left side walls of the package 1. Each dielectric window 3 comprises the feed through unit 3a formed in an almost T-section bar shape and a pair of open end portions 3b attached to both ends of the feed through unit 3a. The open end portions 3b are respectively protruded from both ends of the feed through unit 3a in a direction different from an extending direction of the feed through unit 3a and are respectively formed in a rectangular shape on the dielectric wall surface.

Each dielectric window 3 is attached to both the package base 1a and the seal ring 1c of the package 1 in a brazing process. Therefore, the both side walls of the package 1 shown on the right and left sides in FIG. 2A are respectively composed of one dielectric window 3, the package base 1a and the seal ring 1c. Because each dielectric window 3 is mainly made of the dielectric substance, the dielectric window 3 functions as a radio wave window through which the electromagnetic wave is transmitted.

As is additionally shown in FIG. 3 and FIG. 4 in detail, 4 indicates each of a plurality of lead terminals (or lead lines) placed in the feed through unit 3a of each dielectric window 3, and signals sent from external units are received in the lead terminals 4. 5 indicates each of a plurality of signal lines (lead line) connected to the lead terminals 4, and the signal lines 5 are inserted and embedded in each dielectric window 3. 5b indicates a ground lead element of the signal lines 5 of each dielectric window 3. 6 indicates a driver IC (or driver circuit) for reshaping a high-frequency signal, which is transmitted through the dielectric window 3 placed on the left side and is degraded in the transmission, and adjusting the high-frequency signal to a signal level required in the optical semiconductor element 2. The driver IC 6 is placed on a screen portion 1d projected from the bottom portion of the package base 1a of the package 1.

Also, 7 indicates a constant temperature element (for example, Peltier element) for keeping the temperature of the optical semiconductor element 2 to a constant value. The constant temperature element 7 is placed on the package base 1a of the package 1. 8 indicates a metal carrier (or a sub-carrier) for adjusting the height of a lens. 9 indicates an insulator for electrically insulating the constant temperature element 7 from the metal carrier 8, and the insulator 9 is placed between the constant temperature element 7 and the metal carrier 8. 10 indicates a lens window which is placed in a window portion opened in a side wall (a right side wall in FIG. 1) of the package 1 and is formed in an almost circular shape. The optical signal radiated from the optical semiconductor element 2 according to the high-frequency signal is transmitted through the lens window 10.

11 indicates a base plate (or a chip carrier) placed on the metal carrier 8, and the optical semiconductor element 2 is placed on the base plate 11. A difference in the height between the optical semiconductor element 2 and one lead terminal 4 receiving a voltage signal is adjusted by the base plate 11. 12 indicates each of a plurality of connection lines. The high-frequency signal sent from one lead terminal 4 of the dielectric window 3 placed on the left side in FIG. 2A to one signal line 5 is sent to the base plate 11 through the connection lines 12 and the driver IC 6, the voltage signal sent from one lead terminal 4 of the dielectric window 3 placed on the right side in FIG. 2A to one signal line 5 is sent to the base plate 11 through another connection line 12, and the optical signal is radiated from the optical semiconductor element 2 according to the high-frequency signal and the voltage signal.

13 indicates a first lens for converging the optical signal radiated from the optical semiconductor element 2, and a positional relationship between the first lens 13 and the optical semiconductor element 2 is adjusted by the metal carrier 8. 14 indicates an optical interface unit for leading the optical signal converged in the first lens 13 to the outside of the package 1 through the lens window 10 placed on the front side of the package 1. 15 indicates an optical fiber for receiving the optical signal through the optical interface unit 14 and leading the optical signal to another device.

In the optical interface unit 14, 16 indicates an optical isolator for leading the optical signal converged in the first lens 13 to the optical fiber 15 almost without attenuation and intercepting a laser beam returned from the optical fiber 15. 17 indicates a second lens for again converging the optical signal transmitting through the optical isolator 16 on an end surface of the optical fiber 15. 18 indicates a ferrule connecting the optical fiber 15 and the package 1 of the optical module. Therefore, the optical module is formed in a hermetic structure due to the metal package 1, the optical interface unit 14 and the dielectric window 3 made of the dielectric substance. Also, all surfaces of the optical module other than both the dielectric window 3 and the lens window 10 are covered with the metal package 1, and the optical module is shielded from the external electromagnetic wave.

As shown in FIG. 4, each dielectric window 3 having the function of the feed through unit 3a is formed in an almost U shape in section in cases where the dielectric window 3 is seen from the front of the side wall of the package 1. In other words, the dielectric window 3 is formed in an almost U shape on a dielectric side wall surface of the package 1. In this case, the dielectric window 3 on the dielectric side wall surface of the package 1 has the same shape as that of a plane of a Ridge waveguide perpendicular to a tube axial direction of the waveguide. The Ridge waveguide is used for the transmission of micro waves. Therefore, the dielectric window 3 can function as a type of Ridge waveguide. It is generally well known that the Ridge waveguide has a frequency characteristic of a broad pass band. In the first embodiment, the dielectric window 3 is formed in the almost U shape on the dielectric side wall surface of the package 1 so as to be surrounded by a conductive wall having an open window formed in the almost U shape. The conductive wall having the almost U shaped open window has a ridge-shaped protruding portion which projects into the U shaped open window, and the protruding portion of the conductive wall is formed in the ridge shape.

Sizes (an external length A₁, an internal length A₂, an external width B₁ and an internal width B₂) of the dielectric window 3 formed in the almost U shape on the dielectric side wall surface of the package 1 are shown in FIG. 4. A lower cutoff frequency (or a basic mode cutoff frequency) Fc₁ of the dielectric window 3 for the electromagnetic wave passing through the dielectric window 3 is calculated according to equations (2) and (3).

Fc₁=C₀/{π√(εᵣ)×√{(2C_{d}/ε₀+A₂/B₂)(A₁−A₂)B₁}} (2)

and

C_{d}=ε₀/χ×{(1+χ²)/χ×cos h⁻¹{(1+χ²)/(1−χ²)}−2×ln{4χ/(1−χ²)}}χ=B₂/B₁ (3)

Here, εᵣ denotes a relative dielectric constant of the dielectric substance of the dielectric window 3. ε₀ (≈8.854×10⁻¹² F/m) denotes a vacuum space dielectric constant. Also, because a relative magnetic permeability μᵣ is normally equal to 1, μᵣ=1 is set. Also, a higher cutoff frequency of a high frequency zone does not exist.

The equations (2) and (3) are obtained by referring to “Calculation of the Parameters of Ridge Waveguides” written by TSUNG-HAN CHEN, IEEE TRANS MTT-5, April 1957, No. 2.

Next, a difference in the lower cutoff frequency between the radio wave window formed in the rectangular shape on the dielectric wall surface of the feed through unit 102 in the conventional optical module and the dielectric window 3 formed in the almost U shape on the dielectric wall surface according to the first embodiment will be described below.

FIG. 5 is a diagonal view showing a general rectangular waveguide.

A lower cutoff frequency in the radio wave window formed in the rectangular shape can be obtained by calculating a lower cutoff frequency in a rectangular waveguide shown in FIG. 5. Here, an electromagnetic wave is transmitted in a tube axial direction of the rectangular waveguide, a longer width (or a lengthwise width) in a plane perpendicular to the tube axial direction of the rectangular waveguide is set to the value A₁ which is the same as the external length of the dielectric window 3 formed in the almost U shape according to the first embodiment. In cases where the rectangular waveguide is packed with the dielectric substance of the relative dielectric constant εᵣ, a lower cutoff frequency Fc₀ of the rectangular waveguide for the electromagnetic wave is calculated according to an equation (4). Here a higher cutoff frequency in the rectangular waveguide in a high frequency zone does not exist in the same manner as in the dielectric window 3 formed in the almost U shape.

Fc₀=C₀/{2A₁×√(εᵣ)} (4)

A ratio of a cutoff frequency Fc₁ in the dielectric window 3 formed in the almost U shape and the cutoff frequency Fc₀ in the rectangular waveguide is calculated according to an equation (5).

Fc₁/Fc₀=2A₁/{π√{(2C_{d}/εᵣ+A₂/B₂)(A₁−A₂)B₁}} (5)

The ratio Fc₁/Fc₀ indicates a degree, to which the lower cutoff frequency is decreased, in cases where the dielectric window 3 formed in the almost U shape is used in place of the rectangular waveguide. For example, shape conditions A₁=6 mm, A₂=4 mm, B₁=3 mm, B₂=1 mm, and εᵣ=9 are set, the lower cutoff frequency Fc₁≈5.83 GHz in the dielectric window 3 and the lower cutoff frequency Fc₀≈8.33 GHz in the rectangular waveguide and the ratio Fc₁/Fc₀≈0.7 are obtained. This result indicates that the lower cutoff frequency can be lowered by about 30% in cases where the dielectric window 3 formed in the almost U shape is used in place of the rectangular waveguide without changing the longer width. In other words, the cavity resonance of the electromagnetic wave in the cavity 20 of the optical module can be weakened due to the decrease of the lower cutoff frequency by about 30%.

Therefore, the lower cutoff frequency Fc₁≈5.83 GHz of the electromagnetic wave in the dielectric window 3 is sufficient lowered than the frequency Fr≈10.6 GHz of the low order cavity resonance obtained according to the equation (1), and unnecessary electromagnetic waves of frequencies higher than the lower cutoff frequency Fc₁≈5.83 GHz can be reliably transmitted through the dielectric window 3.

Also, in another point of view, the ratio Fc₁/Fc₀ indicates a degree, to which the relative dielectric constant of the dielectric substance can be lowered, in cases where the dielectric window 3 formed in the almost U shape is used in place of the rectangular waveguide. In cases where the relative dielectric constant of the dielectric substance of the dielectric window 3 is set to εᵣ=4.4 in the above shape conditions, the lower cutoff frequency Fc₁≈8.34 GHz can be obtained. This lower cutoff frequency is almost the same as the lower cutoff frequency Fc₀≈8.33 GHz in the rectangular waveguide using the dielectric substance of the relative dielectric constant εᵣ=9. This result indicates that a dielectric substance of a low relative dielectric constant can be used for the dielectric window 3 in cases where the dielectric window 3 formed in the almost U shape is used in place of the rectangular waveguide without changing the longer width. In other words, the reflection factor of the unnecessary electromagnetic waves on the surface of the dielectric window 3 can be lowered without changing the lower cutoff frequency in cases where the dielectric window 3 formed in the almost U shape is used in place of the rectangular waveguide.

Also, because the lower cutoff frequency Fc₁≈8.34 GHz in the dielectric window 3 using the dielectric substance of the relative dielectric constant εᵣ=4.4 for the electromagnetic wave is lower than the frequency Fr≈10.6 GHz of the low order cavity resonance of the package 1 obtained according to the equation (1), unnecessary electromagnetic waves of frequencies higher than the lower cutoff frequency Fc₁≈8.34 GHz can be reliably transmitted through the dielectric window 3 using the dielectric substance of the relative dielectric constant εᵣ=4.4.

Next, a degree of reflectance of the electromagnetic wave on the dielectric window 3 with respect to the relative dielectric constant of the dielectric substance will be described below. Here, to simplify the description, it is assumed that plane waves are transmitted through the dielectric window 3, and the intensity of electromagnetic field is changed only in a propagation direction of the plane waves.

A reflection coefficient Γ of the plane waves on a boundary surface in case of an incident angle set to 0 degree is expressed according to an equation (6).

Γ={1−√(εᵣ)}/{1+√(εᵣ)} (6)

Here the relative magnetic permeability μᵣ=1 of the dielectric substance is set.

In the equation (6), |Γ|=0.5 is obtained in case of the relative dielectric constants εᵣ=9 of the dielectric substance. Also, |Γ|=0.354 is obtained in case of the relative dielectric constant εᵣ=4.4 of the dielectric substance. Therefore, it is realized that the reflection coefficient Γ of the plane waves is lowered as the relative dielectric constant is lowered. Here, though the reflection coefficient Γ of a negative value is obtained, the reflection coefficient Γ of a negative value indicates that the phases of the reflected waves are inverted as compared with those of the plane waves. Therefore, the reflection coefficient of the plane waves are expressed by the absolute value of the reflection coefficient Γ.

Incident conditions of the electromagnetic wave on the boundary surface between the cavity 20 of the optical module and the dielectric window 3 differ form those of the plane waves because the intensity of the electromagnetic field actually depends on the place and time in a three-dimensional space. However, in the same manner as in the plane waves, a reflection coefficient Γ of the electromagnetic wave on the boundary surface between the cavity 20 of the optical module and the dielectric window 3 is lowered as the relative dielectric constant is lowered. Therefore, in cases where the dielectric window 3 is packed with the dielectric substance of a low relative dielectric constant, the electromagnetic wave of the cavity 20 can be transmitted through the dielectric window 3 at a high transmittance, and the cavity resonance can be effectively weakened.

Next, a method of manufacturing the package 1 so as to hermetically seal the optical module will be described below.

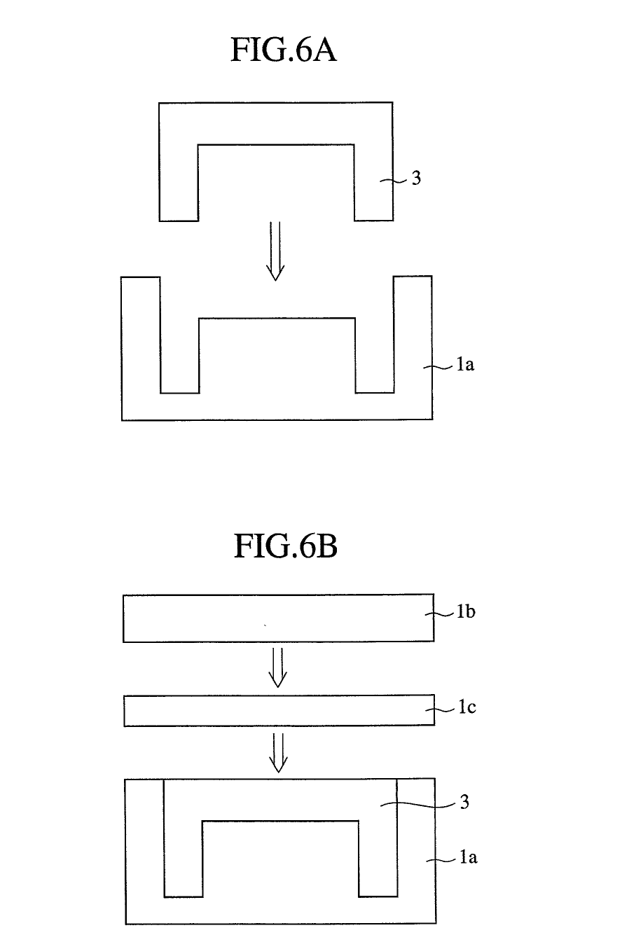

FIG. 6A shows a step of placing the dielectric window 3 on the package base 1a, and FIG. 6B shows a step of placing the package cover 1b and the seal ring 1c on the dielectric window 3.

As shown in FIG. 6A, the metallic package base 1a having a bottom plane and four side walls are prepared. In the package base 1a, an open window (not shown) is formed at a position corresponding to the lens window 10, a pair of cut-out areas formed in an almost U shape are formed at positions of two side walls corresponding to the dielectric windows 3. Also, the dielectric windows 3 formed in the almost U shape matching with the cut-out areas are prepared. The dielectric windows 3 are packed with the dielectric substance and are formed in the structure shown in FIG. 3. Thereafter, each dielectric window 3 is fitted into the corresponding cut-out area of the package base 1a and is brazed. Therefore, a package box with the dielectric windows 3 additionally having the function of the feed through unit 3a is obtained. The upper area of the package box is opened.

Thereafter, as shown in FIG. 6B, the metallic seal ring 1c is mounted on upper ends of the side walls of the package box, and the metallic seal ring 1c is covered with the package cover 1b formed of a metallic plate. Thereafter, the package box, the metallic seal ring 1c and the package cover 1b are heated so as to tightly connect the package base 1a to the package cover 1b through the metallic seal ring 1c. Therefore, the dielectric window 3 is surrounded by a wall portion. The wall portion is made of only a conductive substance. In other words, the wall portion is an edge part of the dielectric window 3. Thereafter, the lens windows 10 is tightly fitted into the open window of the package base 1a. Therefore, the package 1 hermetically sealing the optical module can be manufactured.

Next, an operation of the optical module will be described below.

As shown in FIG. 2, a high-frequency signal sent from the outside is lead into the package 1 through one lead terminal 4 and one signal line 5 of the dielectric window 3 placed on the left side, and the high-frequency signal is reshaped and adjusted in the driver IC 6 and is received in the optical semiconductor element 2. Also, a voltage signal sent from the outside is lead into the package 1 through both one lead terminal 4 and one signal line 5 of the dielectric window 3 placed on the right side and the base plate 11, and the voltage signal is received in the optical semiconductor element 2. In the optical semiconductor element 2, an optical signal having the intensity corresponding to the voltage signal is produced according to the adjusted high-frequency signal, and the optical signal is sent to the optical fiber 15 through the lens 3 and the optical interface 14.

In this production of the optical signal, a part of the high-frequency signal is scattered in the cavity 20 as unnecessary electromagnetic waves, and the unnecessary electromagnetic waves are likely to generate the cavity resonance. However, most of the unnecessary electromagnetic waves of the cavity 20 are transmitted through the dielectric windows 3, which are packed with the dielectric substance and are formed in the almost U shape on the dielectric side wall surface, and are discharged to the outside. Therefore, the intensity of the unnecessary electromagnetic waves in the cavity 20 can be considerably reduced.

As is described above, in the first embodiment, the dielectric windows 3 including the feed through units 3a are packed with the dielectric substance and are formed in the almost U shape on the dielectric wall. Therefore, the lower cutoff frequency of the dielectric windows 3 for the unnecessary electromagnetic waves can be considerably lowered, the unnecessary electromagnetic waves including low-frequency electromagnetic waves can be reliably transmitted through the dielectric windows 3 and are discharged to the outside. Accordingly, the cavity resonance of the unnecessary electromagnetic waves including low-frequency electromagnetic waves can be reliably weakened in the cavity 20, and the optical signal output from the optical module is not degraded.

Also, in the conventional optical module, because the radio wave window is formed with a packed ceramic of a high relative dielectric constant εᵣ ranging from 9 to 10, the reflection coefficient of the electromagnetic wave on the surface of the radio wave window is high. Therefore, the electromagnetic wave is not sufficiently transmitted through the radio wave window, and a problem has arisen that unnecessary electromagnetic waves generated due to the scattering of a part of the high-frequency signal in the package cannot be sufficiently discharged to the outside through the radio wave window. Also, to lower the reflection coefficient of the electromagnetic wave on the surface of the radio wave window, it is required to form the radio wave window with a packed dielectric substance (for example, cordierite) of a low relative dielectric constant εᵣ (for example, εᵣ=4.8). In this case, a problem has arisen that a lower cutoff frequency in the radio wave window is heightened.

However, in the first embodiment, because the dielectric window 3 formed in the almost U shape on the dielectric wall is arranged in each of both the side walls of the package 1, the dielectric window 3 can be made of a dielectric substance having a low relative dielectric constant while maintaining the lower cutoff frequency to the almost same value as that in the conventional optical module. Therefore, the transmittance of the unnecessary electromagnetic waves in the dielectric window 3 can be considerably heightened. In this case, the reflection coefficient of the unnecessary electromagnetic waves on the surface of the dielectric window 3 is considerably reduced, and the intensity of the unnecessary electromagnetic waves remaining in the cavity 20 can be considerably reduced. Accordingly, the cavity resonance of the unnecessary electromagnetic waves occurring in the cavity 20 can be reliably weakened.

Also, in the first embodiment, because each dielectric window 3 having the function of the feed through unit 3a is formed without lengthening a size of the longer side of the dielectric window 3 on the dielectric side wall surface as compared with that of the feed through unit 102 of the conventional optical module, the size of the longer side of the dielectric window 3 can be shorter than that of the corresponding side wall of the package 1. Accordingly, the dielectric window 3 can be easily arranged in the side wall of the package 1.

Also, in the first embodiment, because no electromagnetic wave absorptive element causing the occurrence of the outgas is used, the cavity resonance of the unnecessary electromagnetic waves occurring in the cavity 20 can be weakened without degrading the performance of the optical module.

In the first embodiment, a window area formed in the almost U shape is formed in each of both the side walls of the package 1, and each window area is packed with a dielectric substance such as ceramic to form the dielectric window 3. However, it is applicable that a window area formed in the almost U shape be formed in only one side wall of the package 1 and the window area is packed with a dielectric substance such as ceramic to form the dielectric window 3 having the function of the feed through unit 3a. For example, there is probability that the transmission of the unnecessary electromagnetic waves through the dielectric window 3 is disturbed by the screen portion 1d which is placed on the package base 1a of the package 1 to arrange the driver IC 6. Therefore, to avoid the disturbance of the transmission of the unnecessary electromagnetic waves due to the screen portion id, it is preferable that the dielectric window 3 be arranged only in the side wall of the package placed on the right side in FIG. 2B.

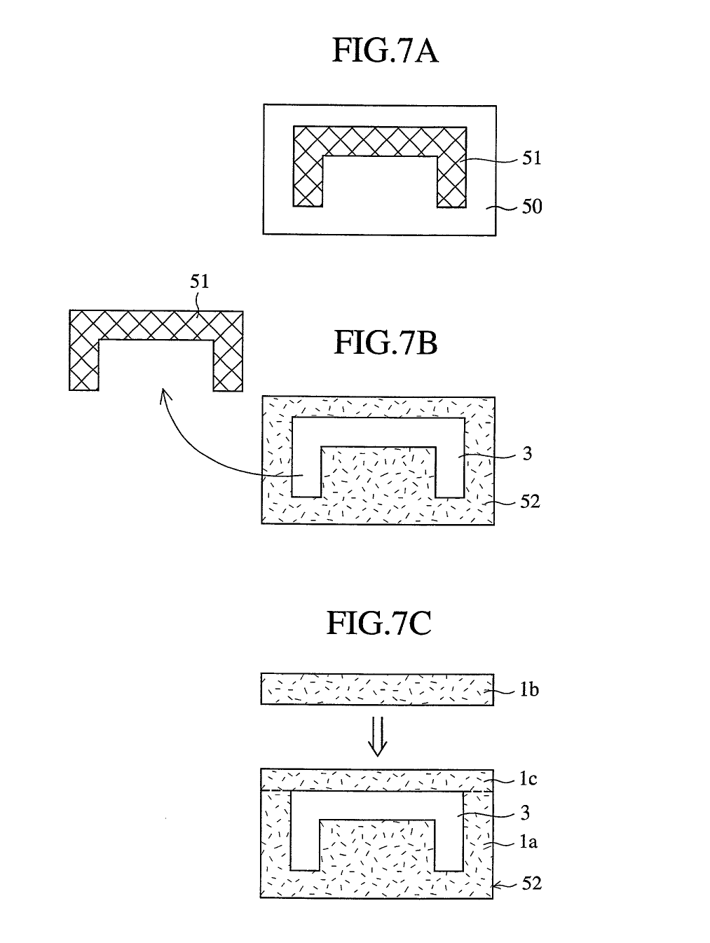

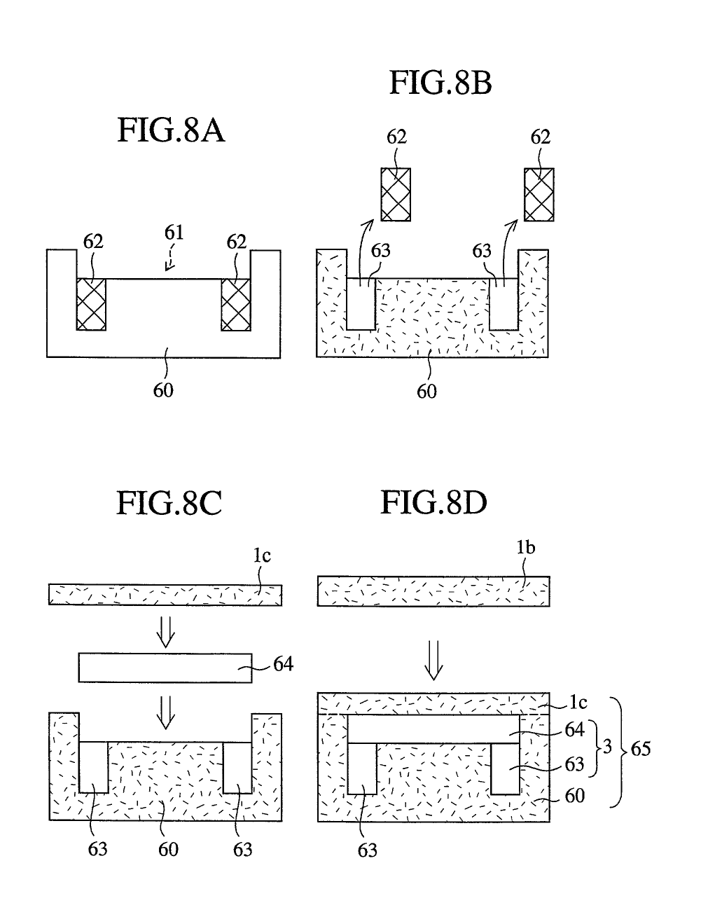

Also, in the first embodiment, the package 1 made of a conductive substance is used to shield the high-frequency signal and the voltage signal of the optical module from the external electromagnetic wave. However, it is not necessarily required to use the package 1 made of a conductive substance. For example, it is applicable that a surface (an inner wall surface or an outer wall surface) or both surfaces of the package 1 made of a dielectric substance be metallized by covering the surface or both surfaces with a thin metallic film to obtain the metallized package 1. The electromagnetic wave is cut off by the metallized package 1. The formation of the metallized package 1 is shown in FIG. 7 and FIG. 8 and is described later in detail.

Also, in the first embodiment, the lower cutoff frequency Fc₁ of the dielectric window 3 for the electromagnetic wave is lowered than the frequency Fr of the low order cavity resonance occurring in the package 1. Therefore, unnecessary electromagnetic waves, of which the frequencies are higher than the lower cutoff frequency Fc₁, can be transmitted through each dielectric window 3. However, the first embodiment is not limited to the dielectric window 3 through which the unnecessary electromagnetic waves caused by the low order cavity resonance are transmitted. For example, it is applicable that the lower cutoff frequency Fc₁ of the dielectric window 3 for the electromagnetic wave be set to be equal to a frequency of a high order cavity resonance which is higher than the frequency Fr of the low order cavity resonance. In this case, unnecessary electromagnetic waves having frequencies equal to or higher than the frequency of the high order cavity resonance can be transmitted through the dielectric window 3.

Next, the manufacturing of a metallized package will be described below.

FIG. 7A, FIG. 7B and FIG. 7C are explanatory views showing the procedure of manufacturing the package 1 according to a first modification of the first embodiment. The sidewall of the package 1 shown in the front and left of FIG. 1 is shown in FIG. 7A, FIG. 7B and FIG. 7C.

As shown in FIG. 7A, a step of metallizing a dielectric box 50, of which the upper side is opened, is initially performed. In detail, the dielectric box 50, which has an open window (not shown) at a position corresponding to the lens window 10 and is made of a dielectric substance, is prepared. A portion of the dielectric box 50 corresponding to each dielectric window 3 with the function of the feed through unit 3a has the structure shown in FIG. 3, and the lead terminals 4, the signal lines 5 and the ground lead element 5b are embedded in advance in the portion of the dielectric box 50. A shape of the dielectric box 50 is the same as that of a combination of the package base 1a, the seal ring 1c and the dielectric windows 3. The dielectric box 50 is, for example formed by assembling four dielectric blocks having the same shapes as those of the package base 1a, the seal ring 1c and the two dielectric windows 3 and heating the four dielectric blocks so as to be tightly attached to each other.

Thereafter, the portion of the dielectric box 50 corresponding to each dielectric window 3 is covered with a mask 51 formed in an almost U shape. The mask 51 is used to prevent the portion of the dielectric box 50 from being metallized, and the mask 51 is arranged on either the inner side wall or the outer side wall of the dielectric box 50 or on both the inner and outer side walls of the dielectric box 50. Thereafter, the whole inner side wall, the whole outer side wall or the whole inner and outer side walls of the dielectric box 50, on which the mask 51 or the masks 51 are put, are metallized.

Thereafter, as shown in FIG. 7B, the mask 51 or the masks 51 are removed from the metallized dielectric box 50 to expose the portion of the dielectric block corresponding to each dielectric window 3. Therefore, a package box 52, of which the upper side is opened, is obtained, and each exposed portion of the dielectric block functions as the dielectric window 3. Therefore, the dielectric window 3 is surrounded by a wall portion. The wall portion has a conductive layer and a dielectric layer. In other words, the wall portion is an edge part of the dielectric window 3.

Thereafter, as shown in FIG. 7C, the package cover 1b is put on the package box 52. In detail, to form the package cover 1b, side walls and an upper wall (or a lower wall or both the upper and lower walls) of a dielectric block formed in a plate shape are metallized. In this case, it is applicable that the package cover 1b be made of a conductive substance. Thereafter, the package cover 1b is put on an upper end portion of the package box 52 and is brazed to the package box 52 to tightly connect the package cover 1b to the package box 52. In this case, the flatness of a contact surface between the package cover 1b and the package box 52 is sufficiently set in advance. Therefore, the seal ring 1c is not necessarily required to tightly connect the package cover 1b to the package box 52 through the seal ring 1c. Thereafter, the lens window 10 is fitted in the open window of the package box 52, and the manufacturing of the package 1 is completed.

Here, as is described later, in cases where the package with a dielectric window having no function of the feed through unit 3a is manufactured, it is not required to assemble the four dielectric blocks into the dielectric box 50, but the dielectric box 50 integrally formed is initially prepared, and a portion of the dielectric box 50 corresponding to the dielectric window is covered with the mask 51.

As is described above, in the first modification of the first embodiment, the package 1 formed in a hermetic structure can be made of a dielectric substance. Because the inner side wall, the outer side wall or both the inner and outer side walls of the package 1 other than both the dielectric windows 3 and the lens window 10 are metallized, constitutional elements placed in the package 1 can be shielded from the external electromagnetic wave.

FIG. 8A, FIG. 8B, FIG. 8C and FIG. 8D are explanatory views showing the procedure of manufacturing the package 1 according to a second modification of the first embodiment. The side wall of the package 1 shown in the front and left of FIG. 1 is shown in FIG. 8A, FIG. 8B, FIG. 8C and FIG. 8D.

In the first modification of the first embodiment, the dielectric block having the same structure as each dielectric window 3 shown in FIG. 3 is used. In contrast, in a second modification of the first embodiment, a dielectric block having the same structure as each feed through unit 3a, which is formed of an almost T-section bar as shown in FIG. 3, is used. Here, each feed through unit 3a has the same structure as that of the feed through unit 102 of the conventional optical module.

As shown in FIG. 8A, a dielectric box 60, of which the upper side is opened, is prepared. The dielectric box 60 has an open window (not shown) at a position corresponding to the lens window 10 and has a pair of grooves 61 on the upper ends of two side walls opposite to each other. Each groove 61 is formed in a rectangular shape in section. To fit a dielectric block 64, which has the same structure as that of the feed through unit 3a formed of an almost T-section bar, into each groove 61 in a later step, a sectional shape of each groove 61 agrees with that of the feed through unit 3a. Thereafter, a pair of surface areas of the dielectric box 60 extending from both right and left ends of each groove 61 in a lower direction are covered with rectangular masks 62 respectively. The rectangular masks 62 are used to prevent the surface areas of the dielectric box 60 from being metallized. The rectangular masks 62 are put on the inner wall surface, the outer wall surface or both the inner and outer wall surfaces of the dielectric box 60. Thereafter, the whole inner wall surface, the whole outer wall surface or both the whole inner and outer wall surfaces of the dielectric box 60, on which the rectangular masks 62 are put, are metallized.

Thereafter, as shown in FIG. 8B, the rectangular masks 62 are removed from the dielectric box 60, and a plurality of dielectric portions 63 formed in a rectangular shape are exposed. Here, in cases where two dielectric portions 63 and the dielectric block 64 having the same structure as that of the feed through unit 3a are combined, the dielectric window 3 shown in FIG. 3 is formed. Also, the dielectric box 60 other than the dielectric portions 63 corresponds to the package base 1a.

Thereafter, as shown in FIG. 8C, the dielectric block 64 having the same structure as that of the feed through unit 102 of the conventional optical module is fitted into each groove 61. In this case, because both ends of each dielectric block 64 come in contact with two dielectric portions 63, each dielectric window 3 formed in the almost U shape on the dielectric wall surface is substantially made of the combination of the dielectric block 64 and the two dielectric portions 63. Thereafter, the seal ring 1c is put on the upper portion of the dielectric box 60 so as to place the dielectric block 64 between the dielectric box 60 and the seal ring 1c. Therefore, as shown in FIG. 8D, a package box 65, of which the upper portion is opened, is obtained.

Thereafter, to form the package cover 1b, side walls and an upper wall (or a lower wall or both the upper and lower walls) of a dielectric block formed in a plate shape are metallized. In this case, it is applicable that the package cover 1b be made of a conductive substance. Thereafter, as shown in FIG. 8D, the package cover 1b is put on an upper end portion of the package box 65 and is brazed to the package box 65 to tightly connect the package cover 1b to the package box 65. Therefore, the package cover 1b is connected with the package box 65 through the seal ring 1c. Thereafter, the lens window 10 is fitted in the open window of the package box 65, and the manufacturing of the package 1 is completed.

As is described above, in the second modification of the first embodiment, the package 1 formed in a hermetic structure can be made of a dielectric substance. Because the inner side wall, the outer side wall or the inner and outer side walls of the package 1 other than both the dielectric windows 3 and the lens window 10 are metallized, constitutional elements placed in the package 1 can be shielded from the external electromagnetic wave.

In the first embodiment, the dielectric windows 3 formed in the almost U shape are arranged in both the side walls opposite to each other in the package 1. However, the shape of the dielectric windows 3 is not limited to the almost U shape.

Next, the dielectric window 3 formed in a shape other than the almost U shape will be described below.

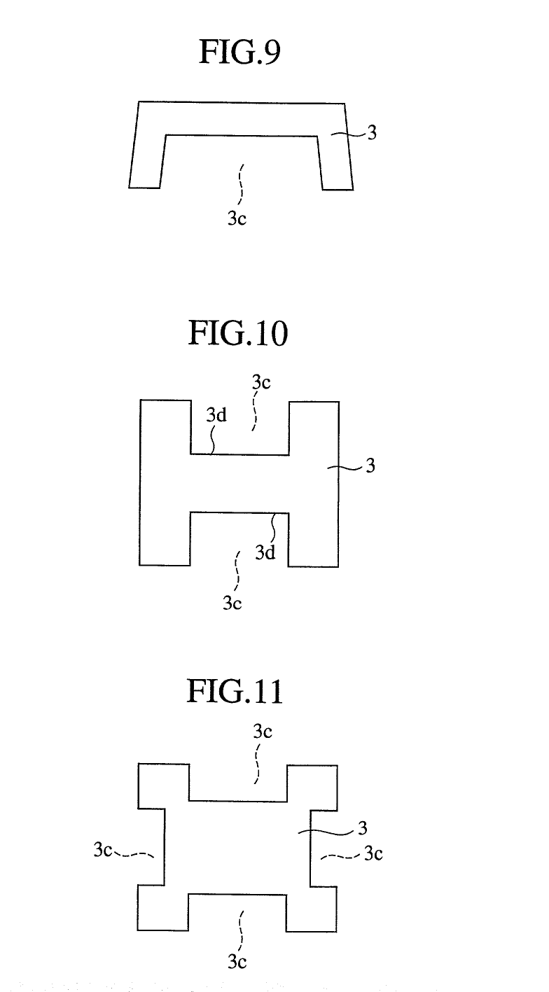

FIG. 9 is a view showing a sectional shape of the dielectric window 3 on the dielectric wall surface according to a third modification of the first embodiment, FIG. 10 is a view showing a sectional shape of the dielectric window 3 on the dielectric wall surface according to a fourth modification of the first embodiment, and FIG. 11 is a view showing a sectional shape of the dielectric window 3 on the dielectric wall surface according to a fifth modification of the first embodiment.

As shown in FIG. 9, the dielectric window 3, which is formed in a shape obtained by outwardly widening both ends of a U shape shown in FIG. 4, is also useful for the optical module.

Also, the first embodiment is not limited to the dielectric window 3 formed in a shape having only one concavity 3c. For example, as shown in FIG. 10, the dielectric window 3, which is formed in an almost H shape having two concavities 3c, is also useful for the optical module.

Also, as shown in FIG. 11, the dielectric window 3, which is formed in a shape obtained by forming a concavity 3c on each of four sides of a rectangle, is also useful for the optical module.

Also, in the first embodiment, it is applicable that a dielectric window having no function of the feed through unit 3a be arranged in the optical module.

Also, the first embodiment is not limited to the dielectric window 3 arranged in the both side walls of the package in which the feed through units 3a are placed. For example, it is applicable that the dielectric window 3 be arranged in a side wall in which the lens window 10 is arranged. Also, it is applicable that the dielectric window 3 be arranged in the upper wall.

Also, in the first embodiment, each dielectric window 3 has the concavity 3c in the lower direction. However, it is applicable that the dielectric window 3 have the concavity 3c in the upper or side direction. In other words, the dielectric window 3 having the concavity 3c in any direction is useful for the optical module.

Embodiment 2

In the first embodiment, the dielectric windows 3 are arranged in the side walls of the package 1 opposite to each other. However, in a second embodiment, a dielectric window formed in an almost U shape on a dielectric side wall surface is arranged on a side wall of the package 1 other than those corresponding to the dielectric windows 3.

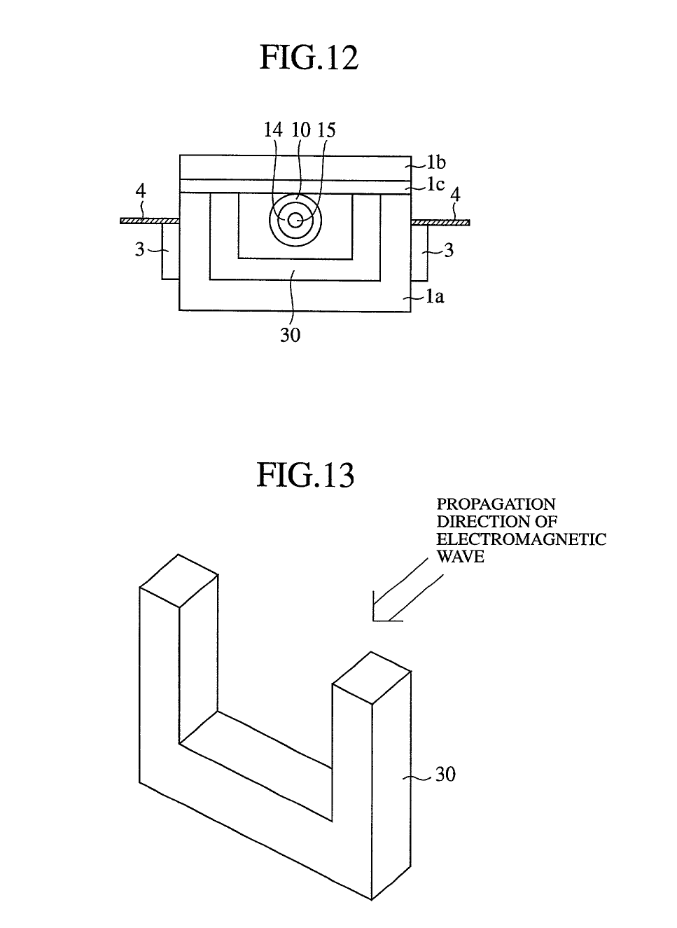

FIG. 12 is a diagonal view showing an external structure of an optical module according to a second embodiment of the present invention, and FIG. 13 is a diagonal view of a dielectric window shown in FIG. 12. An optical module shown in FIG. 12 is seen from the optical interface unit 14. The constituent elements, which are the same as those shown in FIG. 1, are indicated by the same reference numerals as those of the constituent elements shown in FIG. 1, and additional description of those constituent elements is omitted.

In FIG. 12 and FIG. 13, 30 indicates a dielectric window arranged on the front side of the package 1 on which the lens window 10 are placed. The dielectric window 30 is formed by packing a dielectric substance such as ceramic in an opened area arranged on the front side of the package 1 on which the lens window 10 are placed. The dielectric window 30 is formed in an almost U shape on a dielectric wall surface so as to surround the lens window 10. The thickness of the dielectric window 30 in the propagation direction of the electromagnetic wave is the same as that of the package base 1a of the package 1. However, it is applicable that the thickness of the dielectric window 30 be larger than that of the package base 1a of the package 1. In this case, a portion of the dielectric window 30 is protruded from the metallic front wall of the package 1.

The dielectric window 30 is fitted into an opened area formed in the package base 1a in the same manner as in the manufacturing method of the package box shown in FIG. 6.

Next, an operation of the optical module will be described below.

The unnecessary electromagnetic waves scattering in the cavity 20 are transmitted through not only the dielectric windows 3 formed in the almost U shape on the dielectric wall surface but also the dielectric window 30 formed in the almost U shape on the dielectric wall surface and surrounding the lens window 10, and the unnecessary electromagnetic waves are discharged to the outside of the package 1. Therefore, the intensity of the unnecessary electromagnetic waves in the cavity 20 is considerably reduced.

As is described above, in the second embodiment, because the dielectric window 30 formed in the almost U shape on the dielectric wall surface and surrounding the lens window 10 is arranged on the front wall of the package 1 in addition to the dielectric windows 3, unnecessary electromagnetic waves including low-frequency electromagnetic waves are transmitted through not only the dielectric windows 3 but also the dielectric window 30 and are discharged to the outside. Accordingly, the cavity resonance occurring in the cavity 20 due to the unnecessary electromagnetic waves including low-frequency electromagnetic waves can be further weakened.

Also, the dielectric window 30 can be formed by packing the opened area with a dielectric substance of a low relative dielectric constant, and the transmittance of the dielectric window 30 for unnecessary electromagnetic waves scattering in the cavity 20 can be further heightened. Accordingly, the cavity resonance occurring in the cavity 20 due to the unnecessary electromagnetic waves can be further weakened.

Also, because the dielectric window 30 formed in the almost U shape on the dielectric wall surface is arranged on the front wall of the package 1 so as to surround the lens window 10, the dielectric window 30 can be easily arranged on the front wall of the package 1.

In the second embodiment, the dielectric window 30 is formed in the almost U shape on the dielectric wall surface. However, it is applicable that the dielectric window 30 be shaped on the dielectric wall surface in the same manner as that shown in FIG. 9, FIG. 10 or FIG. 11.

Also, in the second embodiment, the dielectric window 30 is arranged in addition to the dielectric windows 3. However, it is applicable that no dielectric window 3 be arranged but only the dielectric window 30 be arranged to weaken the cavity resonance occurring in the cavity 20 due to the unnecessary electromagnetic waves including low-frequency electromagnetic waves. In this case, the feed through units 3a formed in the rectangular shape on the dielectric wall surface are arranged on both the side walls of the package 1 in place of the dielectric windows 3.

Also, in the second embodiment, the package 1 made of a conductive substance is used. However, as shown in FIG. 7 or FIG. 8, it is applicable that the inner wall surface, the outer wall surface or both the inner and outer wall surfaces of the package 1 be metallized to form the metallized package 1 shielded from the electromagnetic wave.

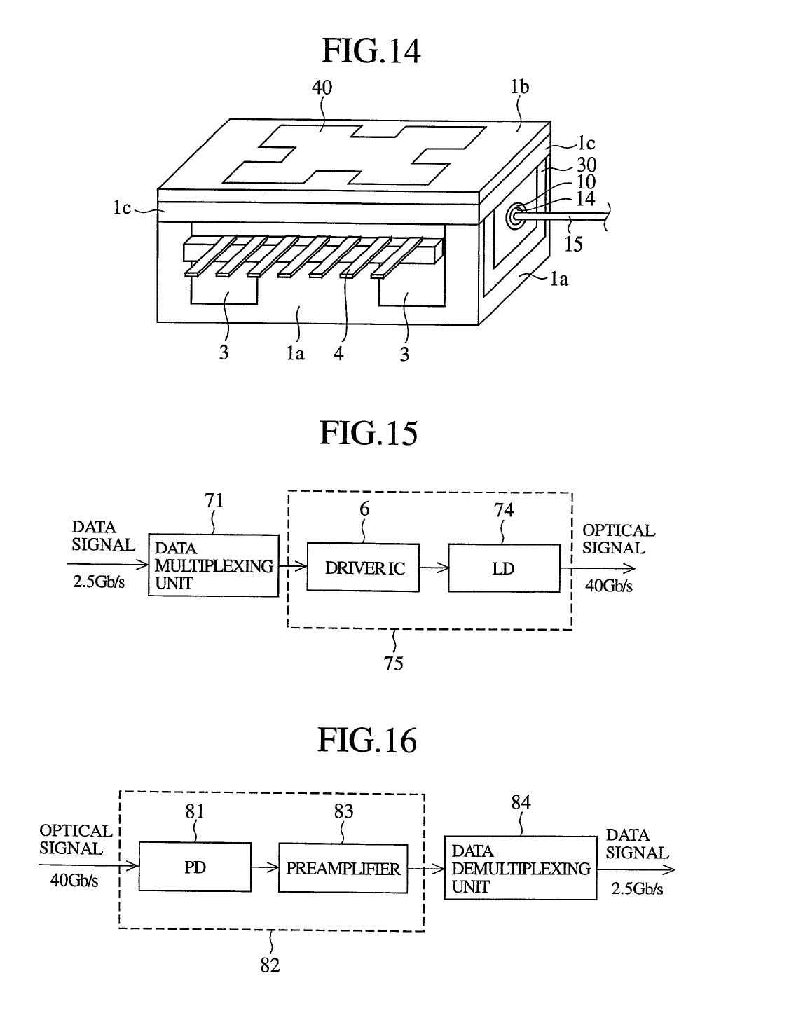

Also, in the second embodiment, the dielectric window 30 formed in the almost U shape on the dielectric wall surface is arranged on the front wall of the package 1 in addition to the dielectric windows 3. However, as shown in FIG. 14, it is applicable that a dielectric window be arranged in the upper wall or another side wall in addition to the dielectric window 30 and the dielectric windows 3.

FIG. 14 is a diagonal view showing an external structure of an optical module according to a modification of the second embodiment.

In FIG. 14, 40 indicates a dielectric window formed by packing a dielectric substance such as ceramic in an open window placed in the package cover 1b of the package 1. The dielectric window 40 has the same sectional shape as that of the dielectric window 3 shown in FIG. 11.

In this modification of the second embodiment, unnecessary electromagnetic waves scattering in the cavity 20 are transmitted through not only the dielectric windows 3 and the dielectric window 30 formed in the almost U shape on the dielectric wall surface but also the dielectric window 40, and the unnecessary electromagnetic waves are discharged to the outside of the package 1. Therefore, the intensity of the unnecessary electromagnetic waves in the cavity 20 is further reduced.

The dielectric window 40 is arranged in the optical module in the same manufacturing procedure as that of the dielectric windows 3 shown in FIG. 6, and the dielectric window 40 is fitted into an open window formed in advance in the package cover 1b. However, the manufacturing procedure of the dielectric window 40 is not limited to that shown in FIG. 6. For example, it is applicable that the package cover 1b is made of a dielectric substance and the inner wall surface, the outer wall surface or the both the inner and outer wall surfaces of the package cover 1b other than an area of the dielectric window 40 are metallized to arrange the dielectric window 40 in the package cover 1b.

Embodiment 3

FIG. 15 is a block diagram showing the configuration of an optical transmitter according to a third embodiment of the present invention, and FIG. 16 is a block diagram showing the configuration of an optical receiver according to the third embodiment of the present invention. The constituent elements, which are the same as those shown in FIG. 2A and FIG. 2B, are indicated by the same reference numerals as those of the constituent elements shown in FIG. 2A and FIG. 2B, and additional description of those constituent elements is omitted.

An optical transmitter having the optical module will be described with reference to FIG. 15. The optical module has the package of which the structure is described in the first or second embodiment, and a laser diode is arranged in the optical module as the optical semiconductor element.

In FIG. 15, 71 indicates a data multiplexing unit (or a multiplexer) for multiplexing a plurality of electric signals (for example, sixteen electric signals) respectively set to a transfer rate of 2.5 Gb/s to an electric signal set to a transfer rate of 40 Gb/s. 74 indicates a laser diode. 75 indicates an optical module described in the first or second embodiment and having the driver IC 6 and the laser diode 74. A level of the electric signal obtained in the data multiplexing unit 71 is amplified in the driver IC 6 to produce a modulated signal (or a high-frequency signal). Thereafter, the modulated signal is received in the laser diode 74 to drive the laser diode 74 denoting the optical semiconductor element, and the modulated signal is converted into an optical signal set to the transfer rate of 40 Gb/s. Thereafter, the optical signal is output from the laser diode 74 to the outside of the optical module 75. Therefore, the data multiplexing unit 71 and the driver IC 6 function as an interface unit of the laser diode 74.

In the example shown in FIG. 15, the driver IC 6 is arranged in the optical module 75. However, it is applicable that the driver IC 6 be arranged on the outside of the optical module 75.

As is described above, the laser diode 74 is driven according to the high-frequency signal which is produced in the driver IC 6 from the electric signal of the data multiplexing unit 71, and the optical signal set to the transfer rate of 40 Gb/s is output from the laser diode 74. The optical signal output from the laser diode 74 is transmitted to an external device (for example, an optical receiver) through the optical fiber 15.

Next, an optical receiver having the optical module will be described with reference to FIG. 16. The optical module has the package of which the structure is described in the first or second embodiment, and a photo diode is arranged in the optical module as the optical semiconductor element.

In FIG. 16, 81 indicates a photo diode for receiving an optical signal transmitted from a sending side through an optical fiber and converting the optical signal into an electric signal. 83 indicates a preamplifier for amplifying the electric signal including a high-frequency signal output from the photo diode 81. 82 indicates an optical module, having the photo diode 81 and the preamplifier 83, for amplifying and outputting the electric signal obtained in the photo diode 81. 84 indicates a data demultiplexing unit (or a demultiplexer) for demultiplexing the electric signal (for example, a signal set to a transfer rate of 40 Gb/s) output from the preamplifier 83 to a plurality of electric signals (for example, sixteen electric signals respectively set to the transfer rate of 2.5 Gb/s) and outputting the electric signals as a plurality of data signals. The data signals are transmitted to an external device through a plurality of signal lines not shown. In this third embodiment, the preamplifier 83 and the data demultiplexing unit 84 function as an interface of the photo diode 81.

In the example shown in FIG. 16, the preamplifier 83 is arranged in the optical module 82. However, it is applicable that the preamplifier 83 be arranged on the outside of the optical module 82.

As is described above, the optical signal transmitted through the optical fiber is converted into the electric signal in the optical module 82 using the photo diode 81, and the electric signal is demultiplexed to a plurality of electric signals. Therefore, the plurality of electric signals are reproduced as a plurality of data signals.

Here, in cases where the optical transmitter shown in FIG. 15 and the optical receiver shown in FIG. 16 are arranged in a box, an optical transceiver corresponding to the data rate of 40 Gb/s can be obtained.

Accordingly, in the third embodiment, the optical transmitter, the optical receiver or the optical transceiver can be manufactured by using the optical module described in the first or second embodiment.

Next, an optical transmitter, in which the optical module 75 having the pair of dielectric windows 3 is shielded from the external electromagnetic wave, will be described below. Here, the driver IC 6 is placed on the outside of the optical module 75.

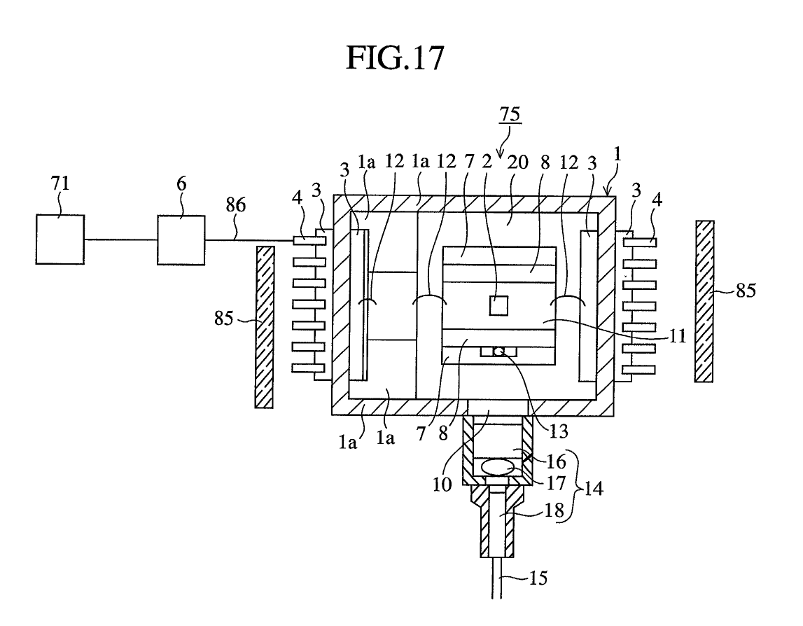

FIG. 17 is a transverse cross sectional view showing the internal configuration of an optical transmitter according to a modification of the third embodiment.

In FIG. 17, the optical module 75 has the pair of dielectric windows 3 shown in FIG. 1, FIG. 2 and FIG. 3. 85 indicates each of a pair of electromagnetic wave absorptive elements which are arranged outside the package 1 of the optical module 75 so as to be closely adjacent to the dielectric windows 3 respectively. The electromagnetic wave absorptive element 85 is formed by mixing ferrite, carbon, a magnetic substance or a conductive fiber material with base material (or organic binder) such as synthetic rubber, fiber reinforced plastics or polyethylene foam. However, it is applicable that the electromagnetic wave absorptive element 85 be formed of conductive resistive films. 86 indicates a signal line through which a modulated high-frequency signal is transmitted from the driver IC 6 to one lead terminal 4 and the optical semiconductor element 2.

Assuming that no electromagnetic wave absorptive element 85 is arranged outside the package 1 of the optical module 75, because each dielectric window 3 of the optical module 75 is made of the dielectric substance, though the unnecessary electromagnetic waves occurring in the cavity 20 of the optical module 75 are discharged to the outside of the optical module 75 through the dielectric windows 3, there is a probability that the external electromagnetic wave penetrates into the optical module 75 through the dielectric windows 3. In particular, because electromagnetic waves of low frequencies can be easily transmitted through the dielectric windows 3, there is a high probability that an external electromagnetic wave of a low frequency penetrates into the optical module 75 through the dielectric windows 3.

However, in the modification of the third embodiment, because the electromagnetic wave absorptive elements 85 are arranged on the outside of the package 1 of the optical module 75 so as to be closely adjacent to the dielectric windows 3 respectively, an external electromagnetic wave directed from the outside of the optical module 75 to the dielectric windows 3 is absorbed in the electromagnetic wave absorptive elements 85 and is attenuated.

In the modification of the third embodiment, the driver IC 6 is placed outside the optical module 75, and the electromagnetic wave absorptive elements 85 are arranged on the outside of the package 1 of the optical module 75 so as to be closely adjacent to the dielectric windows 3 respectively. However, it is applicable that the driver IC 6 be placed in the optical module 75 and the electromagnetic wave absorptive elements 85 be arranged outside the package 1 of the optical module 75 so as to be closely adjacent to the dielectric windows 3 respectively. In this case, the high-frequency signal is transmitted from the data multiplexing unit 71 to the optical semiconductor element 2 through the signal line 86, the lead terminal 4, the dielectric window 3 and the driver IC 6 in that order.

As is described above, in the modification of the third embodiment, because the electromagnetic wave absorptive elements 85 are arranged on the outside of the package 1 of the optical module 75 so as to be closely adjacent to the dielectric windows 3 respectively, the entry of the external electromagnetic wave into the optical module 75 can be prevented. Accordingly, the cavity resonance occurring in the cavity 20 due to the external electromagnetic wave can be reliably weakened.

In the modification of the third embodiment, the signal line 86 passes through the outside of the electromagnetic wave absorptive element 85. However, it is applicable that the signal line 86 penetrate through the electromagnetic wave absorptive element 85. In this case, because the dielectric window 3 can be reliably covered with the electromagnetic wave absorptive element 85, the electromagnetic wave absorptive element 85 can further reliably shield the dielectric window 3 from the external electromagnetic wave.

Embodiment 4

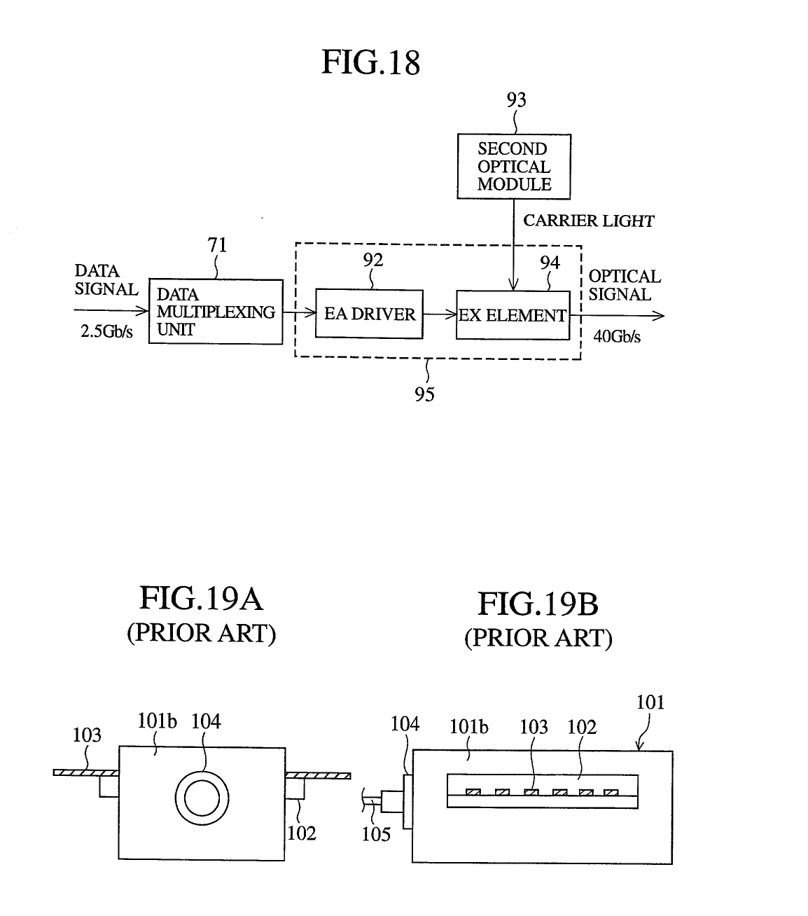

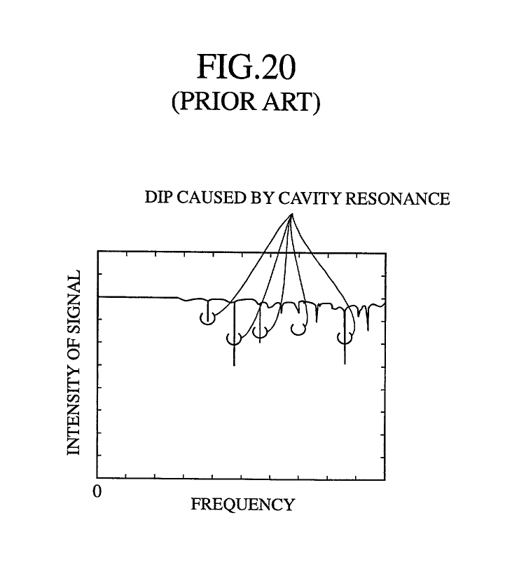

FIG. 18 is a block diagram showing the configuration of an optical transmitter according to a fourth embodiment of the present invention. The constituent elements, which are the same as those shown in FIG. 15, are indicated by the same reference numerals as those of the constituent elements shown in FIG. 15, and additional description of those constituent elements is omitted.

In FIG. 18, 95 indicates a first optical module having a package structure described according to the first or second embodiment. In the first optical module 95, an electroabsorption (EA) element 94 is used as the optical semiconductor element 2. 92 indicates an EA driver (or a driver circuit) for driving the EA element 94. 93 indicates a second optical module having a package structure, for example, described according to the first embodiment. In the second optical module 93, the laser diode 74 is used as the optical semiconductor element 4, and an optical signal having a constant intensity is output as a carrier signal according to an input signal of a constant bias current.

Next, an operation of the optical transmitter will be described below.

A multiplexed data signal obtained in the data multiplexing unit 71 is amplified in the EA driver 92 to produce a modulating signal. The modulating signal includes a high frequency signal. In the EA element 94 of the first optical module 95, a carrier signal output from the second optical module 93 is modulated according to the modulating signal including the high frequency signal output from the EA driver 92 to obtain an optical signal set to the transfer rate of 40 Gb/s, and the optical signal is output.

In the fourth embodiment, the data multiplexing unit 71 and the EA driver 92 function as an interface unit of the EA element 94. Also, in the example shown in FIG. 18, the EA driver 92 is arranged in the first optical module 95. However, it is applicable that the EA driver 92 be arranged on the outside of the first optical module 95.

As is described above, in the fourth embodiment, a plurality of data signals (for example, sixteen data signals) respectively set to the transfer rate of 2.5 Gb/s are transformed into an optical signal set to the transfer rate of 40 Gb/s by using the first optical module 95 with the EA element 94 and the second optical module 93 with the laser diode 74, and the optical signal is sent to an optical receiver through an optical fiber. Accordingly, an optical transmitter can be obtained by using the first optical module 95 and the second optical module 93.

Also, an optical transceiver corresponding to the transfer rate of 40 Gb/s can be, for example, obtained by arranging the optical transmitter shown in FIG. 18 and the optical receiver shown in FIG. 16 in a box.

Also, in the third and fourth embodiments, the optical transmitter and the optical receiver are separately described. However, it is apparent that the optical transmitter and the optical receiver can be arbitrarily combined. Therefore, in addition to the optical transmitter and the optical receiver, the present invention can be applied for an optical transceiver having both an optical transmitting function and an optical receiving function.

What is claimed is:

1. An optical module comprising:
an optical semiconductor element; and
a package, having at least a wall made of both a conductive substance and a dielectric substance, and having a cavity in which the optical semiconductor element is placed, wherein the wall has a window made of the dielectric substance, and the window includes a U-shaped portion.

2. An optical module according to claim 1, wherein the window includes a feed through unit.

3. An optical module according to claim 1, wherein the wall has a wall portion surrounding the window, and the wall portion is made of only a conductive substance.

4. An optical module according to claim 1, wherein the wall has a wall portion surrounding the window, and the wall portion has a conductive layer and a dielectric layer.

5. An optical module according to claim 1, wherein a cut-off frequency of the window for an electromagnetic wave is lower than that of a wave guide of which a lengthwise width is equal to a lengthwise width of the window, and the electromagnetic wave having a frequency higher than the cut-off frequency of the window is transmitted through the window.

6. An optical module according to claim 1, wherein the window is formed of a ridge waveguide.

7. An optical module according to claim 1, wherein a cut-off frequency of the window for an electromagnetic wave is lower than a frequency of a cavity resonance occurring in the package, and the electro-magnetic wave having a frequency higher than the cut-off frequency of the window is transmitted through the window.

8. An optical module according to claim 1, wherein a cut-off frequency Fc₁ of the window for an electro-magnetic wave is approximately expressed according to an equation
$${Fc}_{1} = \frac{{C}_{0}}{π \sqrt{{ϵ}_{r}} \sqrt{( \frac{2 {C}_{d}}{{ϵ}_{0}} + \frac{{A}_{2}}{{B}_{2}} ) ( {A}_{1} - {A}_{2} ) {B}_{1}}}$$
by using an external length A₁ of the window, an internal length A₂ of the window, an external width B₁ of the window, an internal width B₂ of the window, a relative dielectric constant εᵣ of the dielectric substance and a dielectric constant ε₀ of a vacuum, and a coefficient C_{d} is expressed according to equations
$${C}_{d} = \frac{{ϵ}_{0}}{x} \{ \frac{1 + {x}^{2}}{x} {cosh}^{- 1} ( \frac{1 + {x}^{2}}{1 - {x}^{2}} ) - 2 ln ( \frac{4 x}{1 - {x}^{2}} ) \}$$
$$x = \frac{{B}_{2}}{{B}_{1}}$$
by using the dielectric constant ε_{0,} a frequency Fr of a cavity resonance occurring in the package is expressed according to an equation
$$Fr = \frac{{C}_{0}}{2} \sqrt{{( \frac{l}{A} )}^{2} + {( \frac{m}{B} )}^{2} + {( \frac{n}{C} )}^{2}}$$
by using a speed C₀ of light in the vacuum, lengths (in meters) A, B and C of three sides of the package and arbitrary integers l, m and n equal to or higher than 0 satisfying a condition that at least one of the arbitrary integers is not equal to 0, and the external length A₁, the internal length A₂, the external width B₁ and the internal width B₂ in the window and the lengths A, B and C of the package are set so as to make the cut-off frequency Fc₁ of the window lower than the frequency Fr of the cavity resonance occurring in the package.

9. An optical module according to claim 1, wherein a cut-off frequency of the window for an electromagnetic wave is lower than that which is obtained by covering the dielectric substance exposed to the surface of the wall with the conductive substance so as to make the dielectric substance in a rectangular shape, and the electromagnetic wave having a frequency higher than the cut-off frequency of the window is transmitted through the window.

10. An optical module according to claim 1, wherein the package is formed in an almost box shape, and the window is arranged on a surface of the wall of the package.

11. An optical module according to claim 1, wherein an inner surface of the wall of the package is metallized, and the window is arranged on the inner surface of the wall of the package.

12. An optical module according to claim 1, wherein an outer surface of the wall of the package is metallized, and the window is arranged on the outer surface of the wall of the package.

13. An optical module according to claim 1, wherein the package is formed in an almost box shape, and the window is arranged in a side area of the wall of the package.

14. An optical module according to claim 1, wherein the package is formed in an almost box shape, and the window is arranged in an upper area of the wall of the package.

15. An optical module according to claim 1, wherein the package is formed in an almost box shape, and the window is arranged in both a side area and an upper area of the wall of the package.

16. An optical module according to claim 1, wherein the window is formed in a U shape.

17. An optical module according to claim 1, wherein the window is formed in a shape which is obtained by outwardly widening both ends of a U shape.

18. An optical module according to claim 1, wherein the window is formed in an almost H shape.

19. An optical module according to claim 1, wherein the window is formed in a shape which is obtained by forming a concavity on each of four sides of a rectangle.

20. An optical module according to claim 1, wherein the window made of the dielectric substance of the package comprises a feed through unit formed of an almost T-section bar, through which a high frequency signal received or output in/from the optical semiconductor element is transmitted, and a pair of open ends which are respectively protruded from both ends of the feed through unit and are formed in a rectangular shape in section respectively, and an inner surface or an outer surface of the wall of the package except for the window is metallized.

21. An optical module according to claim 1, wherein the package further comprises a lens, through which an optical signal received or output in/from the optical semiconductor element is transmitted, arranged in the wall, and the window is arranged so as to surround the lens.

22. An optical transmitter, comprising:
an interface unit for receiving a plurality of electric signals and outputting a high frequency signal; and
an optical module for receiving the high frequency signal from the interface unit and outputting an optical signal, wherein the optical module comprises:
an optical semiconductor element for producing the optical signal in response to the high frequency signal transmitted from the interface unit; and
a package, having at least a wall made of both a conductive substance and a dielectric substance, and having a cavity in which the optical semiconductor element is placed,
the wall has a window made of the dielectric substance, and the window includes a U-shaped portion.

23. An optical transmitter according to claim 22, further comprising:
an electromagnetic wave absorptive element which is arranged in an outside area of the package so as to face the window of the optical module.

24. An optical transmitter according to claim 22, wherein the interface unit comprises a multiplexer for multiplexing the electric signals to produce the high frequency signal.

25. An optical transmitter according to claim 22, wherein the optical semiconductor element of the optical module is formed of a laser diode, and the interface unit further comprises a driver circuit for amplifying the high frequency signal produced by the multiplexer to output an amplified high frequency signal to the laser diode.

26. An optical transmitter according to claim 22, further comprising a second optical module for receiving an electric signal and outputting a second signal, wherein the optical module is a first optical module having the optical semiconductor element formed of an electroabsorption element, and wherein the first optical module comprises a driver circuit for amplifying the high frequency signal produced by the multiplexer and outputting an amplified high frequency signal to the electroabsorption element to make the electroabsorption element convert the second optical signal output from the second optical module into the optical signal according to the amplified high frequency signal and output the optical signal.

27. An optical transmitter according to claim 26, wherein the driver circuit is placed in the cavity of the package.

28. An optical receiver, comprising:
an optical module for receiving an optical signal and outputting a high frequency signal; and
an interface unit for receiving the high frequency signal from the optical module and outputting electric signals, wherein the optical module comprises:
a photo diode for producing the high frequency signal in response to the optical signal; and
a package, having at least a wall made of both a conductive substance and a dielectric substance, and having a cavity in which the photo diode is placed, the wall has a window made of the dielectric substance, and the window includes a U-shaped portion.

29. An optical receiver according to claim 28, wherein the interface unit comprises a demultiplexer for demultiplexing the high frequency signal produced by the photo diode to produce electric signals.

30. An optical receiver according to claim 29, wherein the interface unit further comprises an amplifier for amplifying the high frequency signal and outputting an amplified high frequency signal to the demultiplexer to make the demultiplexer produce the electric signals from the amplified high frequency signal.
